(19) United States
(12) Patent Application Publication
(10) Pub. No.: US 2017/0157790 A1
(43) Pub. Date: Jun. 8, 2017

(54) METHOD FOR MANUFACTING A BOTTLE SEALING FILM WITH A TEARING TAB AND DEVICE FOR FORMING THE BOTTLE SEALING FILM

(71) Applicants: Fu-Chuan HUANG, Chiayi County (TW); SHANGHAI DASE-SING PACKAGING TECHNOLOGY CO., LTD., Shanghai (CN)

(72) Inventor: Fu-Chuan HUANG, Chiayi County (TW)

(73) Assignees: SHANGHAI DASE-SING PACKAGING TECHNOLOGY CO., LTD., Shanghai (CN); Fu-Chuan HUANG, Chiayi County (TW)

(21) Appl. No.: 14/957,216

(22) Filed: Dec. 2, 2015

(51) Int. Cl. B26D 9/00; B65D 51/18

(52) U.S. Cl. CPC B26D 9/00; B65D 51/185; B65D 2251/0031; B65D 2251/0078

(57) ABSTRACT

A device for forming a bottle sealing film having a tearing tab has a supporting stand, a guiding assembly, a tab-shaping assembly, and a cutting assembly. The guiding assembly has a central post. The tab-shaping assembly has a shaping base, a cutter base, a power driver, a first cutter mount, a second cutter mount, a first cutter, and a second cutter. The second cutter mount is slidably mounted on the cutter base and is connected to and driven by the power driver along the cutter base. The first cutter is mounted the first cutter mount. The second cutter is mounted on the second cutter mount to provide a shearing cut effect in corporation with the first cutter.

### BACKGROUND OF THE INVENTION

1. Field of the Invention

The present invention relates to a method and a machine for forming a bottle sealing film, and more particularly to a method and a machine for forming a bottle sealing film having a tearing tab.

2. Description of Related Art

A conventional bottle has a cap to close an opening of the bottle. An annular bottle sealing film is usually mounted on the cap to seal the opening of the bottle. The bottle sealing film is heated and shrunk to closely mount around the cap. A conventional bottle sealing film is provided by cutting an annular film into pieces by a cutting machine, and the bottle sealing film is mounted round a bottle cap and is heated. The cutting machine substantially comprises a base, multiple blade units and multiple transmission units. The base has a hole defined through the base. The blade units and the transmission units are alternately mounted around the base. Each blade unit has a gear engaging with a gear of a corresponding transmission unit. When a tubular film is led to extend through the hole in the base, the blade units are driven to rotate to cut the tubular film by a driving device with the transmission of the transmission units.

The conventional bottle sealing film is annular and has two flat ends. When the bottle sealing film is mounted around a bottle cap, a round opening is formed in an end of the bottle sealing film and on the bottle cap. To open the bottle cap, the bottle sealing film has to be torn and removed from the cap first. However, the bottle sealing film is not easily torn from the cap due to the toughness of the film. To allow the bottle sealing film to be torn easily, a tearing line is formed longitudinally on the bottle sealing film. The tearing line on the bottle sealing film comprises two columns of bores arranged longitudinally along the bottle sealing film to form a tearing slice on the bottle sealing film. Accordingly, the bottle sealing film can be easily torn and removed from the bottle cap via the tearing slice.

However, because the conventional bottle sealing film has two flat ends, the position of the tearing slice longitudinally formed on the bottle sealing film is not easily found and torn. Therefore, the conventional bottle sealing film is inconvenient in use.

To overcome the shortcomings, the present invention tends to provide a method for manufacturing a bottle sealing film having a tearing tab and a device for forming the same to mitigate or obviate the aforementioned problems.

### SUMMARY OF THE INVENTION

The main objective of the invention is to provide a method and device for manufacturing a bottle sealing film having a tearing tab to allow the bottle sealing film to be torn off easily.

A device for forming a bottle sealing film having a tearing tab has a supporting stand, a guiding assembly, a tab-shaping assembly, and a cutting assembly. The supporting stand has a platform with a hole defined through the platform. The guiding assembly is mounted on the supporting stand and has a central post. The central post has an annular groove and an end. The annular groove is defined around an outer surface of the central post. The end extends through the hole in the platform. The tab-shaping assembly is mounted on the supporting stand and has a shaping base, a cutter base, a power driver, a first cutter mount, a second cutter mount, a first cutter, and a second cutter. The shaping base is mounted on the supporting stand. The cutter base is mounted on the shaping base and has a first end and a second end. The power driver is mounted on the first end of the cutter base. The first cutter mount is mounted on the second end of the cutter base. The second cutter mount is slidably mounted on the cutter base between the first cutter mount and the power driver and is connected to and driven by the power driver along the cutter base. The first cutter is mounted on the first cutter mount. The second cutter is mounted on the second cutter mount to provide a shearing cut effect in corporation with the first cutter. The cutting assembly is mounted on the platform and has a cutting base, multiple blade assemblies, multiple transmission units, and a transmission belt. The cutting base is mounted on the platform. The central post extends through the cutting base. The blade assemblies are mounted in the cutting base and are arranged around the central post. Each blade assembly has a blade corresponding to the annular groove in position to allow the blade to extend into the annular groove. The transmission units are mounted in the cutting base and are connected respectively with the blade assemblies. The transmission belt is mounted around the transmission units to rotate the blades of the blade assemblies synchronously with the transmission of the transmission units.

A method for manufacturing a bottle sealing film comprises steps of:

feeding a film, comprising feeding a flat film reeled around a film reel and moving the film through multiple guiding rods;

forming a tearing tab, comprising leading one side of the fed flat film having a tearing line to a position between a first cutter and a second cutter and forming a tab cutting line on the film by the first cutter and the second cutter;

shaping the film, comprising leading the flat film to a central post from a flat-sided conical head of the central post to form the flat film into a tubular film; and

cutting the film, comprising forming a cutting line on the film that is mounted around the central post by multiple blades rotated synchronously, wherein the cutting line is connected with the tab cutting line;

cutting off the film to form a tubular bottle sealing film having a tearing tab.

Other objects, advantages and novel features of the invention will become more apparent from the following detailed description when taken in conjunction with the accompanying drawings.

### BRIEF DESCRIPTION OF THE DRAWINGS

FIG. 1 is a block diagram of a method for manufacturing a bottle sealing film in accordance with the present invention;

FIG. 2 is a perspective view of a device for forming a bottle sealing film in accordance with the present invention;

FIG. 3 is an enlarged side view of the device in FIG. 2;

FIG. 4 is an enlarged perspective view of a first embodiment of a cutting assembly of the device in FIG. 2;

FIG. 5 is an enlarged perspective view of a tab-shaping assembly of the device in FIG. 2;

FIG. 6 is another perspective view of the tab-shaping assembly in FIG. 5;

FIG. 7 is an exploded perspective view of the tab-shaping assembly in FIG. 5;

FIG. 8 is an enlarged top view of the tab-shaping assembly in FIG. 5;

FIG. 9 is an enlarged side view in partial section of the cutting assembly in FIG. 5;

FIG. 10 is an enlarged end view in partial section of the tab-shaping assembly in FIG. 5;

FIG. 11 is an operational view of the tab-shaping assembly in FIG. 5;

FIG. 12 is another enlarged side view of the tab-shaping assembly in FIG. 5;

FIG. 13 is a side view of a film formed by the method in FIG. 1;

FIG. 14 is a side view of a film provided with a tearing tab formed by the method in FIG. 1; and

FIG. 15 is a perspective of a second embodiment of a cutting assembly in accordance with the present invention.

### DETAILED DESCRIPTION OF PREFERRED EMBODIMENT

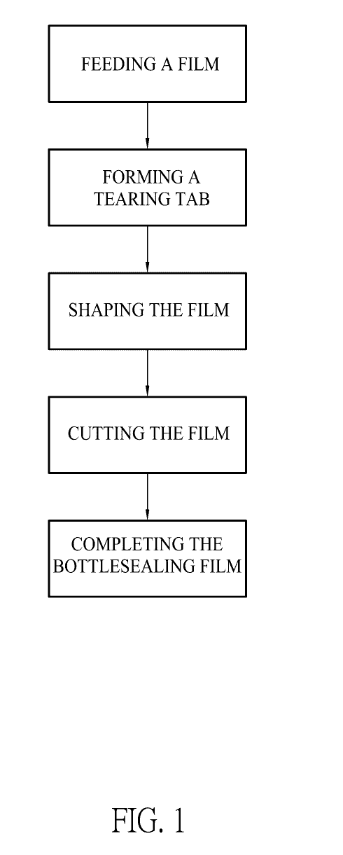

With reference to FIGS. 1, 2, and 3, a method for manufacturing a bottle sealing film having a tearing tab in accordance with the present invention comprises steps of feeding a film, forming a tearing tab, shaping the film, cutting the film and completing the bottle sealing film.

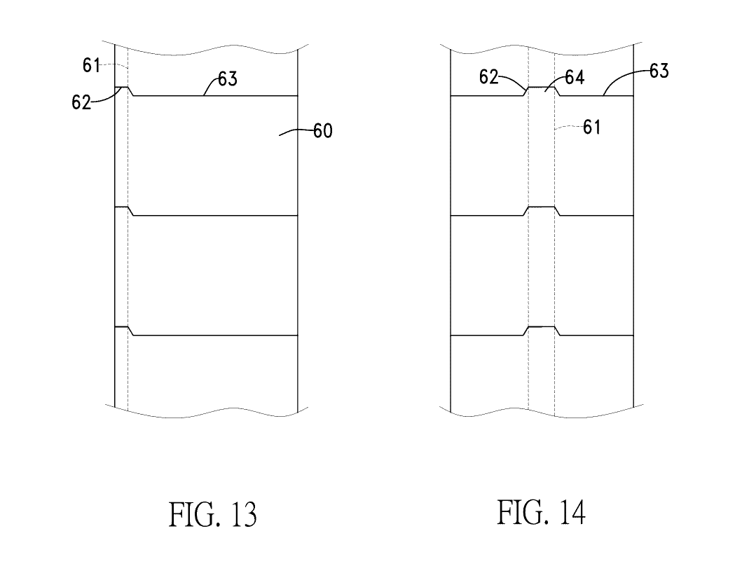

A machine for forming a bottle sealing film in accordance with the present invention comprises a supporting stand 10 and a tab forming device. The supporting stand 10 is mounted on a working station that is applied for manufacturing a bottle sealing film. The supporting stand 10 comprises a platform 11 being adjustable in position, a film reel 12, and a film leading assembly 20. The platform 11 has a hole 110 defined through the platform 11. The film reel 12 is mounted on the supporting stand 10 at a position adjacent to a side of the platform 11, and a film 60 is reeled around the film reel 12. The film 60 is an elongated thin tubular film and is made of a shrink film material. Two folding lines are defined longitudinally in the film 60, such that the film 60 can be compressed to a flat form to be reeled around the film reel 12. With reference to FIGS. 13 and 14, two tearing lines 61 are defined longitudinally on the film 60 and are parallel with each other, and each tearing line 61 comprises multiple bores.

The film leading assembly 20 is mounted on the supporting stand 10 and comprises multiple guiding rods mounted on the supporting stand 10 in pairs. With the guiding rods, the film 60 reeled around the film reel 12 can be led to move downward.

The tab forming device is mounted on the supporting stand 10 to form a tearing tab on the film 60 as shown in FIGS. 13 and 14. The tab forming device comprises a guiding assembly 30, a tab-shaping assembly 40, and a cutting assembly 50.

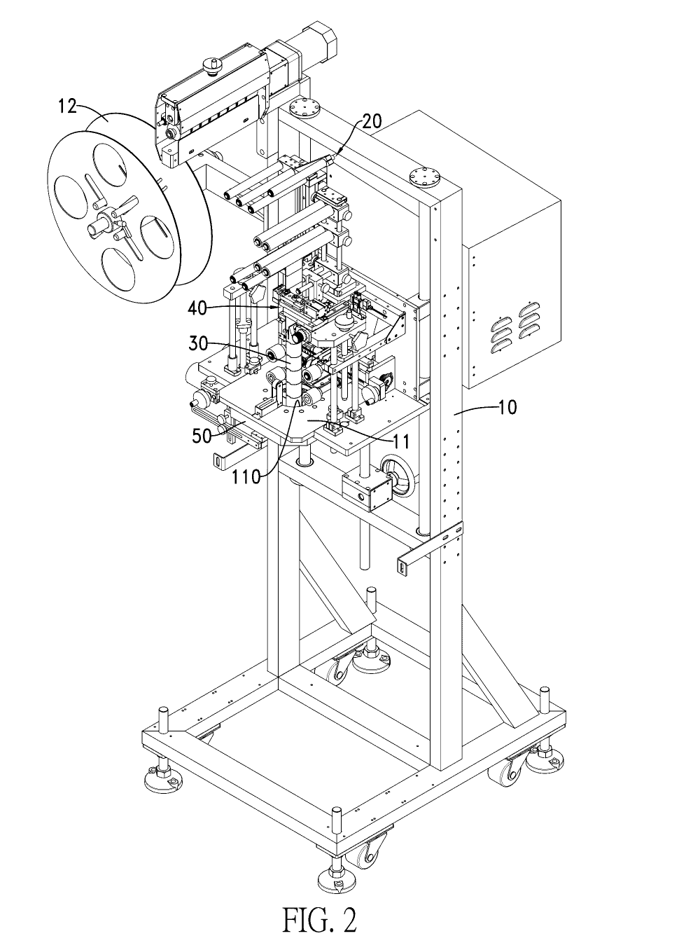

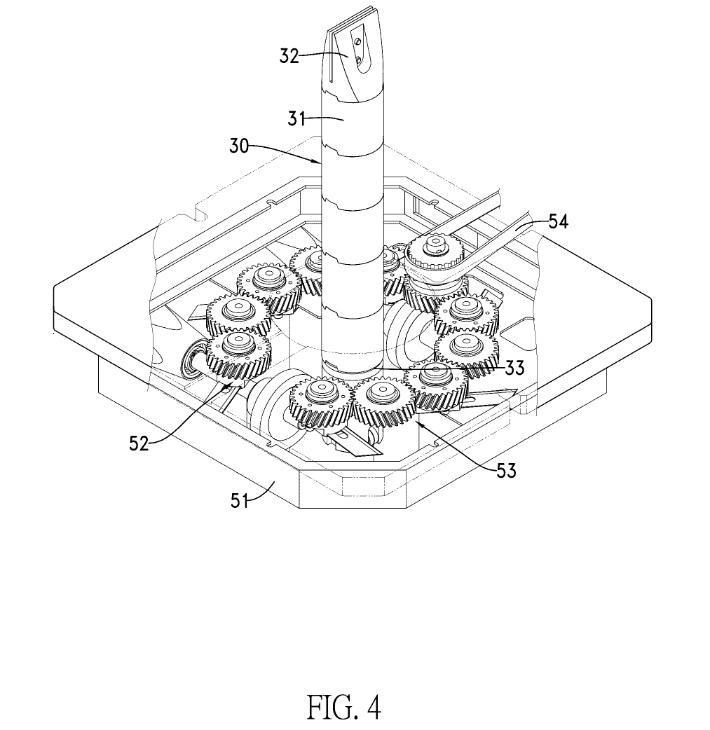

With reference to FIGS. 2 and 4, the guiding assembly 30 is mounted on the supporting stand 10 at a position above the platform 11 and has a central post 31. The central post 31 has a diameter smaller than a diameter of the hole 110 in the platform 11. A flat-sided conical head 32 is formed on a top of the central post 31, such that the flat film 60 can be guided to be mounted around the central post 31 from the flat-sided conical head 32. An annular groove 33 is defined around an outer surface of the central post 31. An end of the central post 31 opposite to the flat-sided conical head 32 extends through the hole 110 in the platform 11.

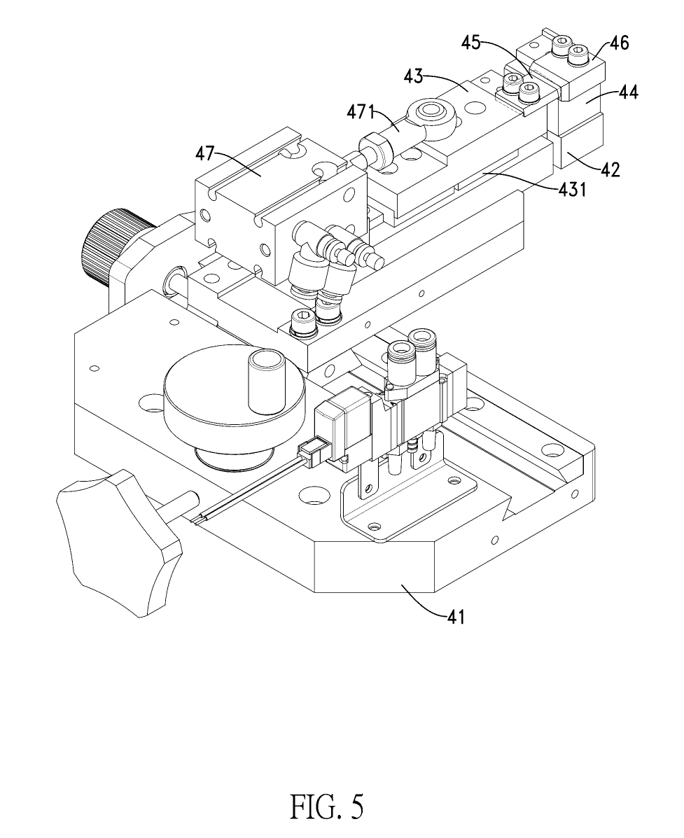

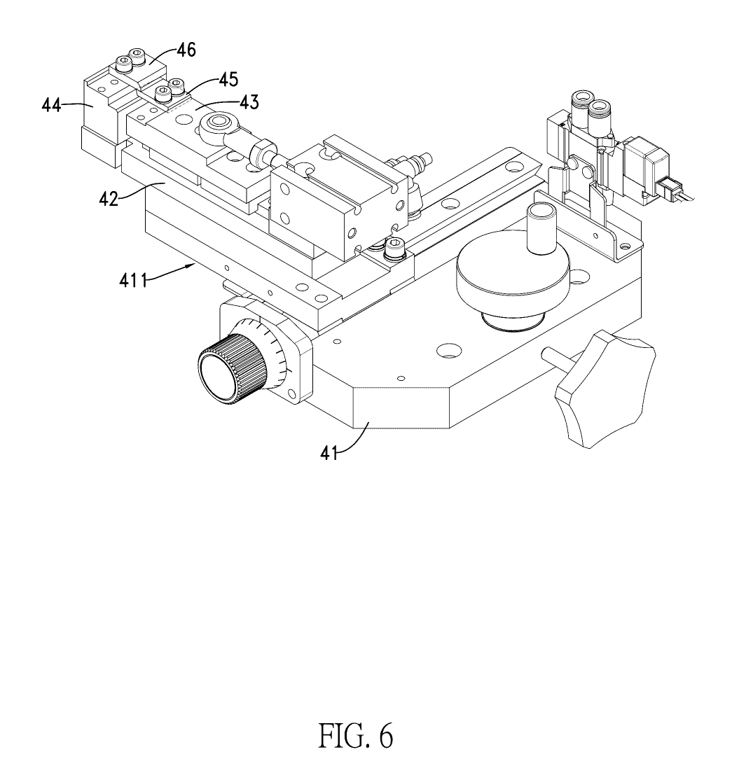

With reference to FIGS. 5 to 7, the tab-shaping assembly 40 is mounted on the supporting stand 10 at a position above the guiding assembly 30 and comprises a shaping base 41, a cutter base 42, a power driver 47, a first cutter mount 44, a second cutter mount 43, a first cutter 46, and a second cutter 45. The shaping base 41 is mounted on the supporting stand 10. The shaping base 41 has a rail assembly 411 mounted on the shaping base 41 and including a lateral rail and a longitudinal rail.

The cutter base 42 may be an elongated board, is mounted on the shaping base 41, and is preferably mounted on the rail assembly 411 on the shaping base 41, such that the cutter base 42 can be moved laterally or longitudinally relative to the shaping base 41. The cutter base 42 comprises a first end, a second end, a stopping block 421, a securing block 423, a guiding block 422, and an escaping notch 420. The stopping block 421 is mounted on the cutter base 42, and the securing block 423 is mounted on the first end of the cutter base 42. The guiding block 422 is mounted on the cutter base 42 between the stopping block 421 and the securing block 423. The escaping notch 420 is defined in the cutter base 42.

The power driver 47 is mounted on the first end of the cutter base 42, is mounted on the securing block 423 on the cutter base 42, and may be a pneumatic cylinder. The power driver 47 comprises a housing and a driving rod 471 connected reciprocally with the housing.

The first cutter mount 44 is mounted on the second end of the cutter base 42. The first cutter 46 is mounted on the first cutter mount 44.

The second cutter mount 43 is slidably mounted on the cutter base 42 between the first cutter mount 44 and the power driver 47, is connected to the driving rod 471 of the power driver 47, and is driven by the power driver 47 to move along the cutter base 42. The second cutter mount 43 has a sliding base 431 mounted on a bottom of the second cutter mount 43. The sliding base 431 has a guiding channel 432 defined in a bottom of the sliding base 431 and mounted around the guiding block 422 on the cutter base 42, such that the second cutter mount 43 is moveably mounted on the cutter base 42. In addition, the stopping block 421 on the cutter base 42 can limit the moving range of the second cutter mount 43. The second cutter 45 is mounted on and moved with the second cutter mount 43, and a shearing cut effect is provided by the second cutter 45 in corporation with the first cutter 46 when the second cutter 45 is moved relative to the first cutter 46.

In addition, the escaping notch 420 is defined in the cutter base 42 at a position corresponding to a position located between the first cutter mount 44 and the second cutter mount 43 and being adjacent to the first cutter mount 44.

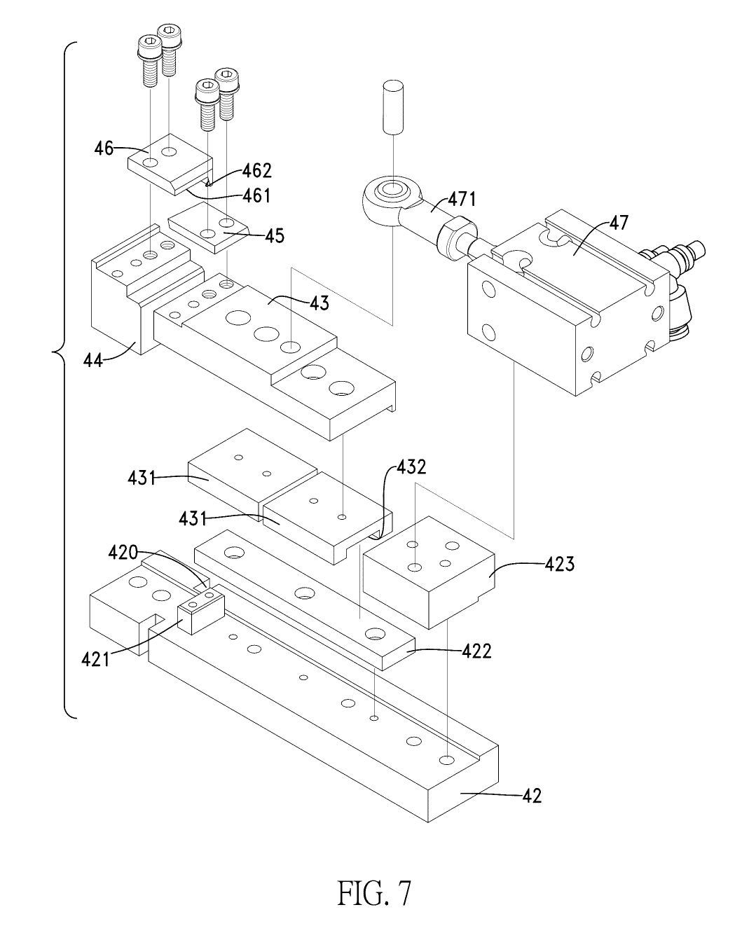

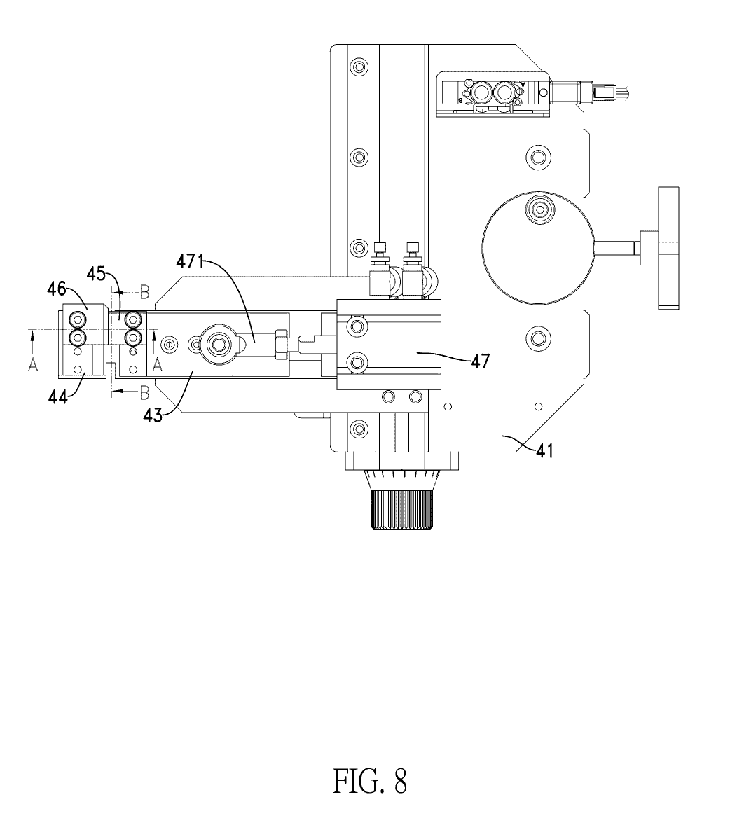

With reference to FIGS. 7 to 10, the second cutter 45 has a blade side formed on one side of the second cutter 45. The blade side comprises a horizontal cutting edge 451 and an inclined cutting edge 452 formed respectively on two adjacent faces of the blade side. The first cutter 46 has a blade receiving recess and a blade side. The blade receiving recess is defined in a bottom of the first cutter 46 to selectively hold the second cutter 45 slidably inside. The blade side is formed in a side of the blade receiving recess and comprises a horizontal cutting edge 461 and an inclined cutting edge 462 formed respectively on two adjacent faces of the blade side of the blade receiving recess.

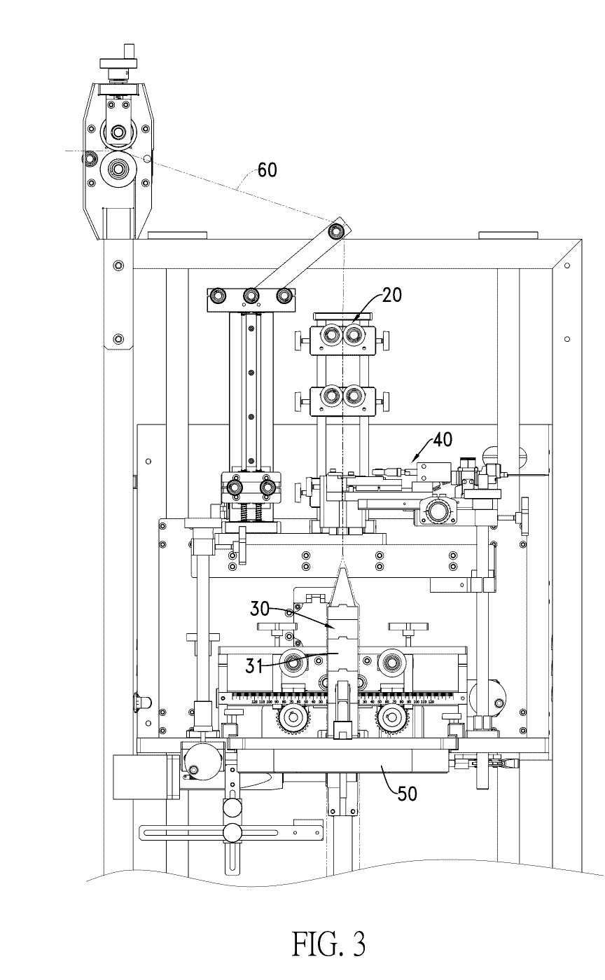

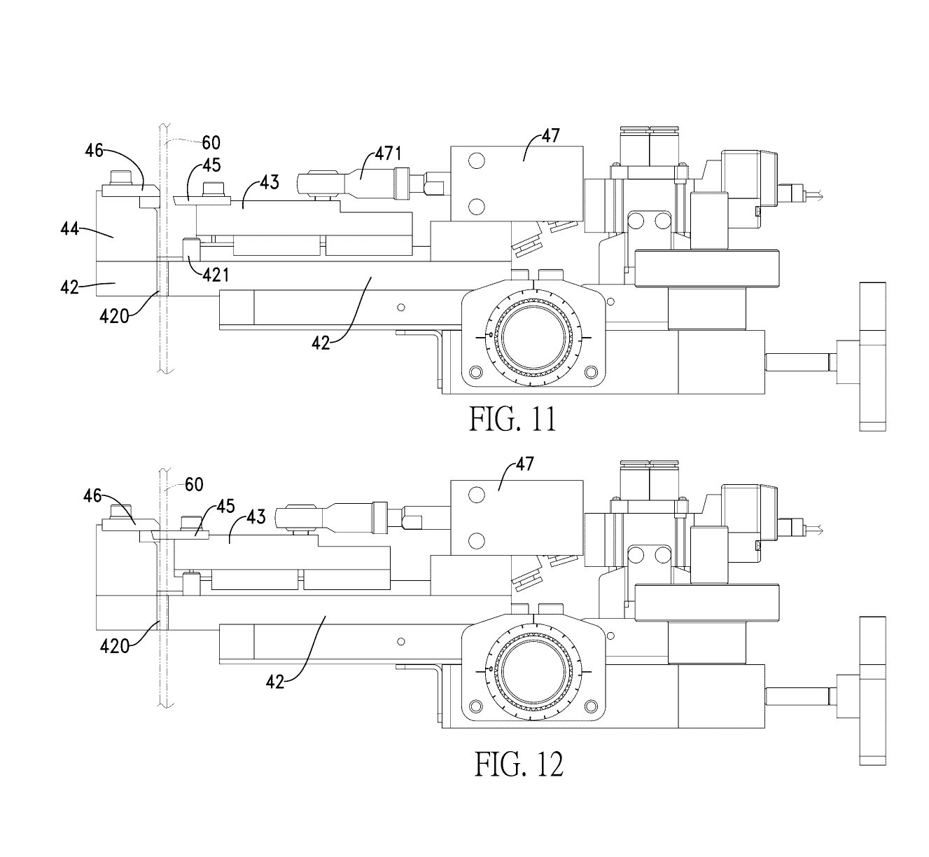

With reference to FIGS. 3 and 11, the flat film 60 is applied from the film reel 12, and is led to move downward to the tab-shaping assembly 40 through the film leading assembly 20. The side of the film 60 provided with the tearing lines 61 passes through a position between the first cutter 46 and the second cutter 45 and through the escaping notch 420. With reference to FIGS. 10 and 12, the second cutter 45 is driven to move toward the first cutter 46 by the power driver 47, such that a tab cutting line 62 as shown in FIGS. 13 and 14 is formed on the film 60 by the shearing effect provided by the first and second knives 45,46.

With reference to FIGS. 2 to 4, the cutting assembly 50 is mounted on the platform 11 and comprises a cutting base 51, multiple blade assemblies 52, multiple transmission units 53, and a transmission belt 54. Preferably, as shown in FIG. 4, six blade assemblies 52 and five transmission units 53 are implemented. The cutting base 51 is hollow to hold the blade assemblies 52 and the transmission units 53 inside. The central post 31 extends through the cutting base 51. The blade assemblies 52 and the transmission units 53 are arranged alternately and around the central post 31. Each blade assembly 52 has a blade and a gear connected with the blade. The blade corresponds to the annular groove 33 in position to allow the blade to extend into the annular groove 33. Each transmission unit 53 comprises a gear engaged with the gear of the corresponding blade assembly 52. The transmission belt 54 is mounted around the transmission units 53 and is connected to a driving unit. Accordingly, the blades of the blade assemblies 52 can be rotated synchronously with the transmission of the transmission units 53 and the transmission belt 54.

With the blades extending into the annular groove 33 in the central post 31, the film 60 mounted around the central post 33 will be cut to form a cutting line 63 on the film 60.

With reference to FIGS. 13 and 14, the distance between the blade and gear of each blade assembly 52 is adjustable, and the position of the cutting line 63 on the film 60 is also adjustable. Two ends of the cutting line 63 are connected with the tab cutting line 62. This means that the cutting line 63 cut by the blades of the blade assemblies 52 is not a complete circle. Accordingly, the film 60 has multiple units each having a tab cutting line 62 and the cutting line 63. Finally, the film 60 is cut into multiple pieces to form multiple bottle sealing films respectively with a tearing tab.

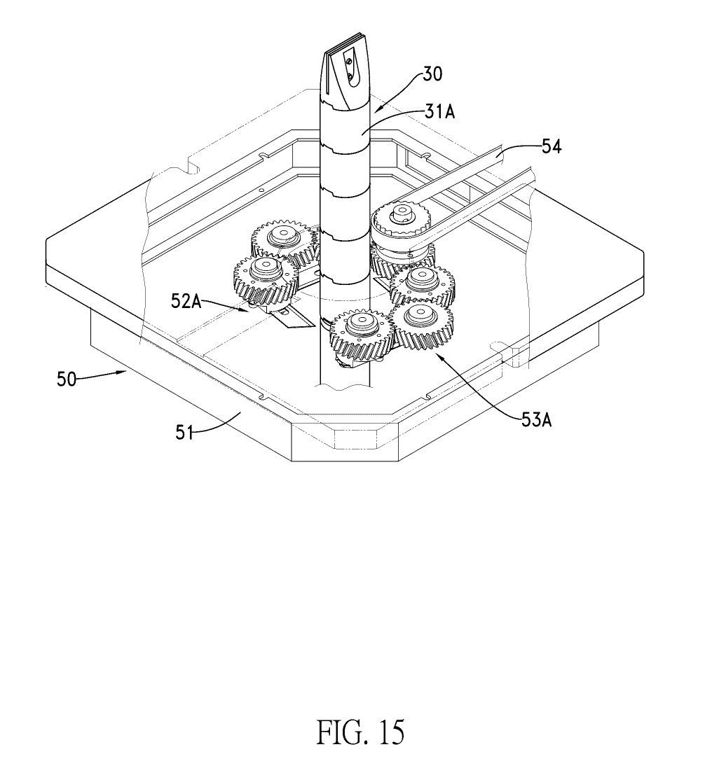

With reference to FIG. 15, in the second embodiment of a cutting assembly 50A in accordance with the present invention, four blade assemblies 52A and three transmission units 53A are implemented. The central post 31A has a diameter smaller than that of the central post 31 in the first embodiment as shown in FIG. 4, such that the central post 31A can be applied to form a bottle sealing film having a smaller diameter.

With reference to FIGS. 1 to 3, in the step of feeding a film, a flat film 60 reeled around the film reel 12 is fed to move downward and guided by the guiding rods of the film leading assembly 20.

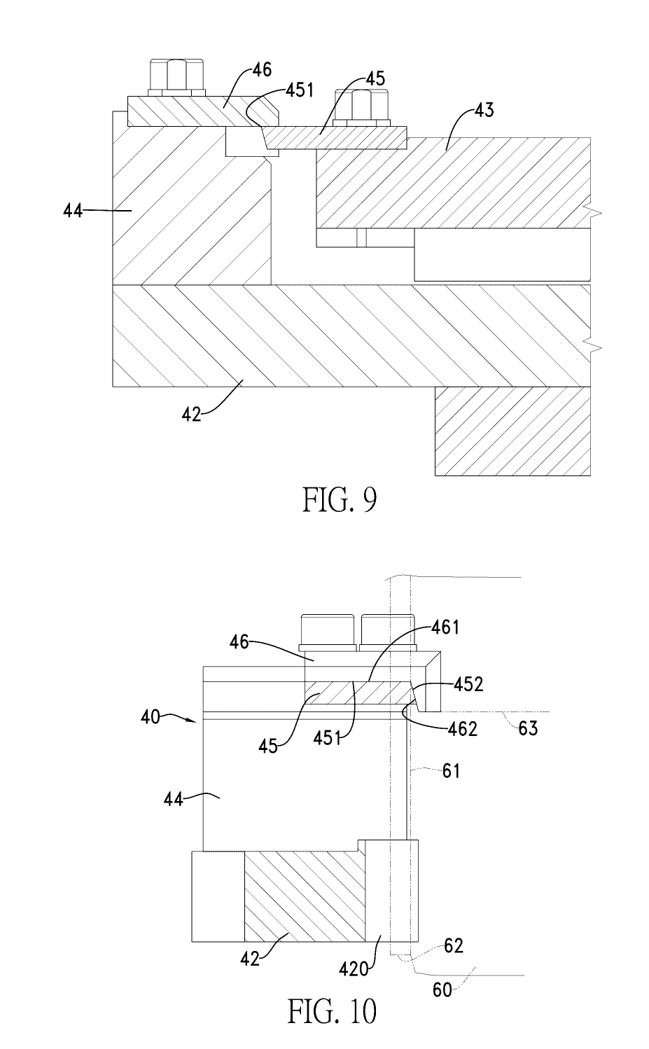

With reference to FIGS. 9 to 12, in the step of forming a tearing tab, the side of the film 60 having the tearing lines 61 is led to pass through the position between the first cutter 46 and the second cutter 45, and a tab cutting line 62 as shown in FIGS. 13 and 14 is formed on the film 60 by the first cutter 46 and the second cutter 45. Thus, a tearing tab 64 is formed on the film 60.

In the step of shaping the film, the flat film 60 is led to the central post 31 from the flat-sided conical head 32 of the central post 31 to form the flat film 60 in a tubular film, and the tubular film 60 is moved downward along the central post 31.

With reference to FIG. 4, in the step of cutting the film, the tubular film 60 is moved along the central post 31 to a position corresponding to the cutting assembly 50, and the blades of the blade assemblies 52 are moved radially toward the central post 31. When the blades extend into the annular groove 33 in the central post 31, a cutting line 63 is formed on the film 60 and is connected with the tab cutting line 62.

Finally, the film 60 is cut off to form a tubular bottle sealing film having a tearing tab 64 as shown in FIG. 14. When the bottle sealing film is mounted around a bottle cap and is heated and shrunk, the tearing tab 64 protrudes from a circular opening defined by an end of the bottle sealing film. Accordingly, the bottle sealing film can be easily torn off and removed from the cap from the protruding tearing tab 64.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A device for forming a bottle sealing film having a tearing tab comprising:
a supporting stand having a platform with a hole defined through the platform;
a guiding assembly mounted on the supporting stand and comprising a central post having
an annular groove defined around an outer surface of the central post; and
an end extending through the hole in the platform;
a tab-shaping assembly mounted on the supporting stand and comprising
a shaping base mounted on the supporting stand;
a cutter base mounted on the shaping base and having a first end and a second end;
a power driver mounted on the first end of the cutter base;
a first cutter mount mounted on the second end of the cutter base;
a second cutter mount slidably mounted on the cutter base between the first cutter mount and the power driver and connected to and driven by the power driver along the cutter base;
a first cutter mounted on the first cutter mount
a second cutter mounted on the second cutter mount to provide a shearing cut effect in corporation with the first cutter; and
a cutting assembly mounted on the platform and comprising
a cutting base mounted on the platform, wherein the central post extends through the cutting base;
multiple blade assemblies mounted in the cutting base and arranged around the central post, and each blade assembly having a blade corresponding to the annular groove in position to allow the blade to extend into the annular groove;
multiple transmission units mounted in the cutting base and connected respectively with the blade assemblies; and
a transmission belt mounted around the transmission units to rotate the blades of the blade assemblies synchronously with the transmission of the transmission units.

2. The device as claimed in claim 1, wherein
the second cutter has a blade side formed on one side of the second cutter and comprising a horizontal cutting edge and an inclined cutting edge formed respectively on two adjacent faces of the blade side; and
the first cutter has
a blade receiving recess defined in a bottom of the first cutter to selectively hold the second cutter slidably inside; and
a blade side formed in a side of the blade receiving recess and comprising a horizontal cutting edge and an inclined cutting edge formed respectively on two adjacent faces of the blade side of the blade receiving recess.

3. The device as claimed in claim 2, wherein
the cutter base further comprises
a stopping block mounted on the cutter base;
a securing block mounted on the cutter base; and
a guiding block mounted on the cutter base between the stopping block and the securing block;
the power driver is mounted on the securing block; and
the second cutter mount has a sliding block mounted slidably on the guiding block.

4. The device as claimed in claim 3, wherein the cutter base has an escaping notch defined in the cutter base at a position corresponding to a position located between the first cutter mount and the second cutter mount and being adjacent to the first cutter.

5. The device as claimed in claim 4, wherein
the cutting base is hollow to hold the blade assemblies and the transmission units inside in an alternate manner;
each blade assembly further has a gear connected with the blade of the blade assembly;
each transmission unit comprises a gear; and
the gears of the transmission units engage with the gears of the blade assemblies.

6. The device as claimed in claim 5, wherein the central post has a flat-sided conical tab formed on a top of the central post.

7. The device as claimed in claim 1, wherein
the cutter base further comprises
a stopping block mounted on the cutter base;
a securing block mounted on the cutter base; and
a guiding block mounted on the cutter base between the stopping block and the securing block;
the power driver is mounted on the securing block; and
the second cutter mount has a sliding block mounted slidably on the guiding block.

8. The device as claimed in claim 7, wherein the cutter base has an escaping notch defined in the cutter base at a position corresponding to a position located between first cutter mount and the second cutter mount and being adjacent to the first cutter.

9. The device as claimed in claim 8, wherein
the cutting base is hollow to hold the blade assemblies and the transmission units inside in an alternate manner;
each blade assembly further has a gear connected with the blade of the blade assembly;
each transmission unit comprises a gear; and
the gears of the transmission units engage with the gears of the blade assemblies.

10. The device as claimed in claim 9, wherein the central post has a flat-sided conical tab formed on a top of the central post.

11. A method for manufacturing a bottle sealing film comprising steps of:
feeding a film, comprising feeding a flat film reeled around a film reel and moving the film through multiple guiding rods;
forming a tearing tab, comprising leading one side of the fed flat film having a tearing line to a position between a first cutter and a second cutter and forming a tab cutting line on the film by the first cutter and the second cutter;
shaping the film, comprising leading the flat film to a central post from a flat-sided conical tab of the central post to form the flat film into a tubular film; and
cutting the film, comprising forming a cutting line on the film that is mounted around the central post by multiple blades rotated synchronously, wherein the cutting line is connected with the tab cutting line;
cutting off the film to form a tubular bottle sealing film having a tearing tab.
